(19) United States
(12) Patent Application Publication
(10) Pub. No.: US 2007/0063391 A1
(43) Pub. Date: Mar. 22, 2007

(54) Preform neck crystallization heating method

(75) Inventor: Kuang-Tse Chin, Nan-Tou City (TW)

Correspondence Address: BIRCH STEWART KOLASCH & BIRCH, PO BOX 747, FALLS CHURCH, VA, 22040-0747, US

(73) Assignee: BOTTLE-TOP DEVELOPMENT CO.

(21) Appl. No.: 11/230,460

(22) Filed: Sep. 21, 2005

(51) Int. Cl. B29C 67/00

(52) U.S. Cl. 264/492

(57) ABSTRACT

The present invention discloses a bottle mouth crystallization heating method, which makes use of external heat energy. When a preform is mounted onto a plug finger of a base by the preform, a first heating source directly heats the external side of the bottle mouth to crystallize the bottle mouth, and a second heating source heats the plug finger of the preform being exposed from the bottom of the plug finger, so that after a heat absorber absorbs the heat, the heat absorber conducts heat energy to the plug finger. The plug finger with heat energy heats the internal side of the bottle mouth simultaneously, therefore to disperse heat energy evenly and rapidly to the internal and external sides of the bottle mouth for crystallization.

### FIELD OF THE INVENTION

The present invention relates to a preform neck crystallization heating method, more particularly to a method for speeding up the crystallization of the polyester bottle mouth that requires crystallization and provides an easy way to be departed from the tools after the manufacturing process is completed.

### BACKGROUND OF THE INVENTION

The traditional polyester container is made of a PET material, and PET refers to the polyethylene terephthalate which is a saturated polyester made by polymerizing the terephthalate and the terephthalatic acid having excellent transparency, glossiness and gas barrier, in compliance with food safety standard, and can be recycled and reused. The glass transition temperature Tg of the PET falls in the range of 75˜85° C., and the injection formation temperature is approximately 270˜310° C., and the mold temperature is approximately 9˜15° C.

Polyester containers have been used extensively for the packaging containers of various different products such as water bottles, juice bottles, soft drink bottles, edible oil bottles, cosmetic bottles, drug bottles, beer bottles, wide-mouth bottles and detergent bottles, etc. Particularly, the growth rate of the market of heat-resisting polyester bottles is much faster than that of the traditional polyester bottles, i.e. carbonatd drink bottles, because the technology for CSD bottles is mature. Therefore, manufacturers turn to develop the heat-resisting polyester bottle market. The heat-resisting polyester bottles can be used in three main areas; the pasteurization bottle can withstand the pasteurized temperature of 65° C. for 20˜30 minutes; the hot-filling temperature bottle can withstand a temperature of 85° C.; and the high temperature hot-filling bottle can withstand a temperature of 120° C.

To achieve the desired quality (particularly, the heat resistance) and the quantity (the maximum production rate) of bottles, two prerequisites are needed: mature manufacturing technology and excellent mechanical equipment. The heat-resisting bottle must go through special processes and keep balance among bottle specification, bottle design, preform design, material properties and technical requirements.

To achieve the high heat resistance and high pressure resistance for the polyester bottles, a crystallization process is conducted at the bottle mouth to improve the physical and mechanical properties such as the heat resistance and pressure resistance, and such crystallization process is generally used in present hot-filling productions.

Please refer to FIG. 1 for the method adopting existing equipments for bottle mouth crystallization, which uses a single external heating source 20 for heating a bottle mouth 11 to crystallize the bottle mouth 11, when the preform 10 is mounted onto a plug finger 31 of a base 30 by the bottle mouth 11. However, this single heating source 20 has a drawback of giving very slow bottle mouth 11 crystallization. Further, when the bottle mouth 11 is crystallized by the single heating source 20, only the external side of the bottle mouth 11 is heated and thus the temperature of the polyester material at the external side of the bottle mouth 11 is higher than the temperature at the internal side and the speed of crystallization at the external side is faster than that at the internal side. The larger the degree of crystallization, the larger the density. Since the larger the density, the smaller the volume, therefore a shrinking radial pressure will be produced between the internal side of the bottle mouth 11 and the plug finger 31. The contracting radial pressure is unfavorable to the separation of the preform from the plug finger 31 after the crystallization process.

### SUMMARY OF THE INVENTION

The primary objective of the present invention is to overcome the shortcomings of the prior-art single heating source with a slow effect of crystallizing a bottle mouth and provide a method for conducting heat energy to a bottle mouth internal side by thermal conduction, so that heat energy can be dispersed quickly and evenly to the bottle mouth as to expedite the bottle mouth crystallization and increase the hardness.

Another objective of the present invention is to heat the bottle mouth on both internal and external sides during the crystallization, so that the manufacturing method of the invention has much lower contracting radial pressure as produced in the prior art, which can separate the preform and the plug finger easier after the crystallization process.

The present invention discloses a bottle mouth crystallization heating method, which makes use of external heat energies. When a preform is mounted onto a plug finger of a base by a bottle mouth, a first heating source directly heats the external side of the bottle mouth to crystallize the bottle mouth, and a second heating source heats a carrier base which is exposed from the bottom of the plug finger, so that after the carrier base absorbs the heat, the carrier base conducts heat energy to the plug finger. The plug finger with heat energy heats the internal side of the bottle mouth at the same time together with external side of the bottle mouth, so that heat energy can be dispersed evenly and rapidly to the bottle mouth for crystallization.

By means of simultaneously heating the internal and external sides of the bottle mouth, the crystallization of the bottle mouth is expedited. After the preform is separated from the heating area and enters into a wind-cooling zone, the external side of the bottle mouth is cooled faster than the internal side; the external side will stop crystallizing while the internal side continues crystallizing. Since the polyester material becomes denser during the crystallization and the density is inversely proportional to the volume, therefore the internal side contracts towards the formed external side and the manufacturing process in accordance with the present invention no longer has a contraction radial pressure produced at the internal side of the bottle mouth and the plug finger according to the prior art. As a result, the preform and the plug finger used for the crystallization according to the present invention can be separated much easier than the prior art.

### BRIEF DESCRIPTION OF THE DRAWINGS

FIG. 1 is an illustrative view of a prior art single heating source.

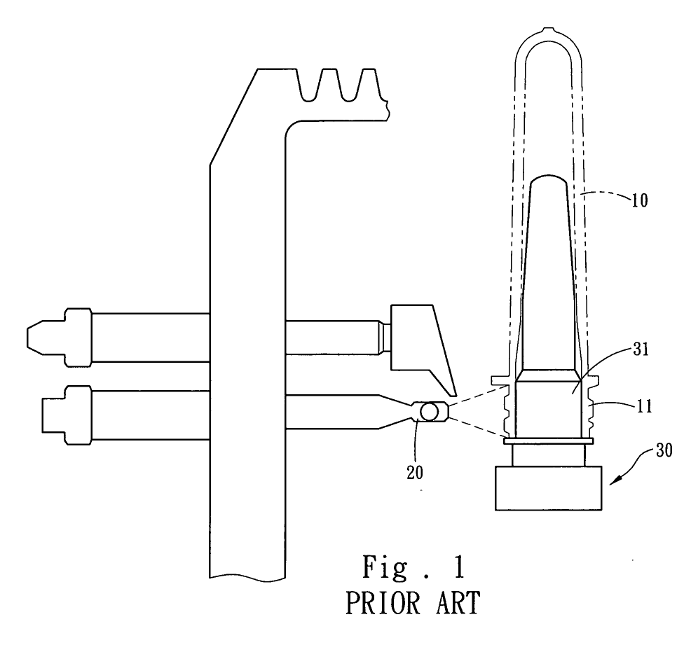

FIG. 2 is an illustrative diagram of a dual heating source of the present invention.

FIG. 3 is an illustrative diagram of a dual heating source according to another preferred embodiment of the present invention.

### DETAILED DESCRIPTION OF THE PREFERRED EMBODIMENTS

To make it easier for our examiner to understand the objective of the invention, its structure, innovative features, and its performance, we use a preferred embodiment together with the attached drawings for the detailed description of the invention.

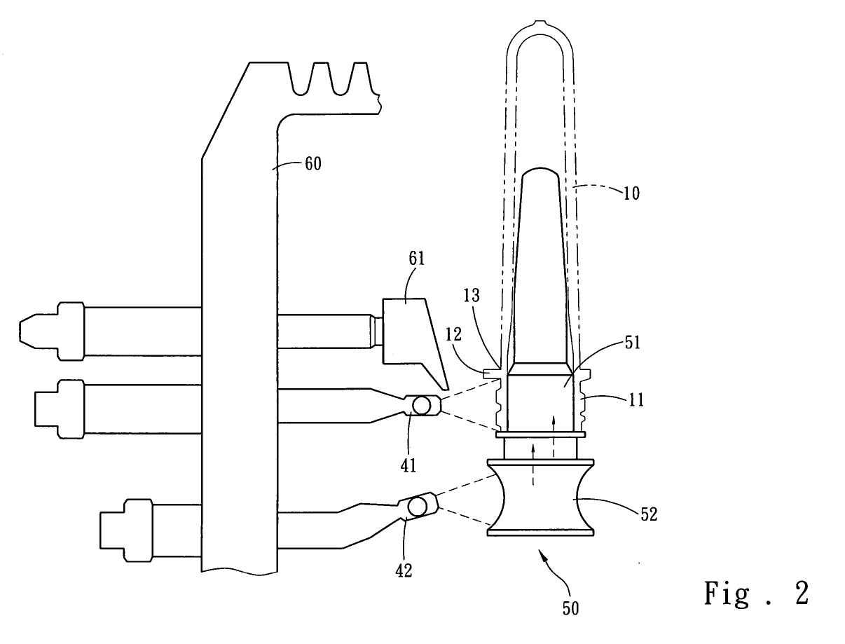

Please refer to FIG. 2 for the illustrative view of the disposed heating source of the present invention. In the figure, it shows a bottle mouth crystallization heating method, which provides a new heating method to crystallize a bottle mouth 11 of a preform 10 (such as a PET polyester bottle). External heat energy is applied, when the preform 10 is placed in a furnace 60 and the preform 10 is mounted onto a plug finger 51 of a base 50 by the bottle mouth 11. A first heating source 41 directly heats the external side of the bottle mouth 11 to crystallize the bottle mouth 11. The first heating source 41 includes a blocking plate 61 disposed at the upper end for shielding the upwardly dispersed radiating heat source of the first heating source 41 to assure that places other than the bottle mouth 11 are heated to produce a crystallization.

The present invention is characterized in that a second heating source 42 is used in addition to the first heating source 41. The second heating source 42 heats a heat absorber 52 underneath the preform 10 that is exposed from the bottom of a plug finger 51, so that after the heat absorber 52 absorbs the heat, the heat absorber 52 conducts heat energy to the plug finger 51, wherein the heat absorber 52 and the plug finger 51 are made of excellent heat conductive materials with a high coefficient of expansion, such as aluminum or copper, and the heat absorber 52 disposed on a lateral side could be a concave surface for increasing the heat absorbability. Therefore, by adding the plug finger 51 with heat energy could be heated both of the internal and external sides of the bottle mouth 11 simultaneously and keep the temperature in a range of 120˜170+ C. for the crystallization, and heat energy can be dispersed evenly and rapidly to the internal and external sides of the bottle mouth 11 required for the crystallization. As a result, the crystallization of the bottle mouth 11 is expedited and the degree of crystallization and hardness of the internal and external sides are higher than those of the middle section inside the bottle mouth since both of the internal and external sides are heated at the same time.

After the preform 10 is passing the heating zone of the single heating source 20 thereafter enters a wind-cooling zone having a wind cooling equipment for fast cooling. Since the external side of the bottle mouth 11 is cooled faster than the internal side by the cooling wind. In other words, the external side will stop crystallizing and form into a fixed shape, but the internal side of the bottle mouth 11 will continue crystallizing because the temperature of the plug finger drops slowly. Since the density of the crystallized polyester material becomes larger, and the density is inversely proportional to the volume, therefore, the internal side is contracted towards the foregoing external side. Then, the volumes of the heat absorber 52 and the plug finger 51 made of good heat conductive materials with a high coefficient of expansion reduce due to the drop of temperature, so that the internal diameter of the plug finger 51 is smaller than that of the bottle mouth 11. Therefore, the manufacturing process according to the present invention will not produce a radial contractive pressure like the prior art and the preform 10 could be separated from the plug finger 51 after the crystallization process much easier than the prior art.

The first heating source 41 and the second heating source 42 could be one of the heating sources selected from a near infrared light source, a far infrared source or an electric-heated hot wind.

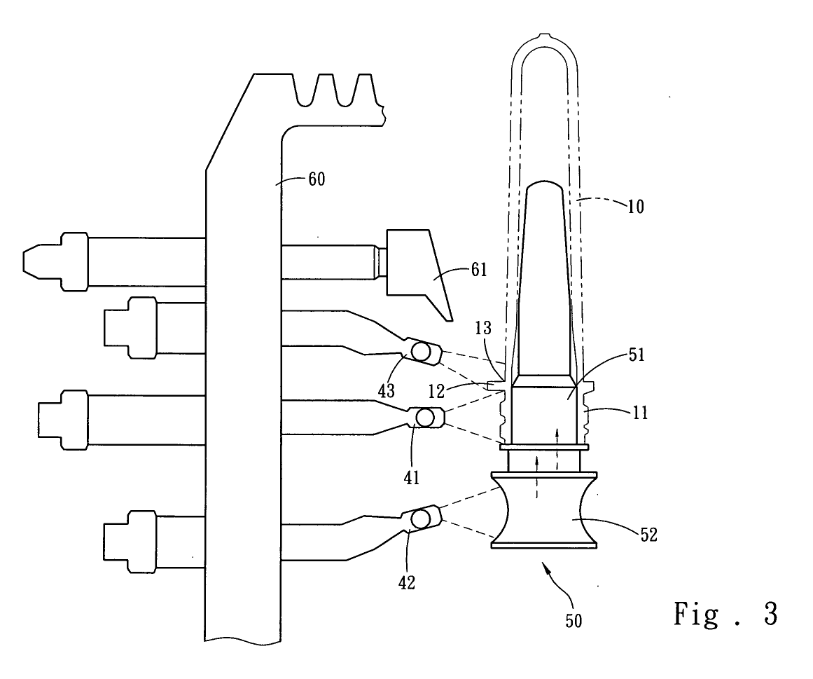

To enhance the physical properties of the entire bottle mouth 11, it is necessary to expand the scope of the crystallization. Please refer to FIG. 3. A third heating source 43 would be further added upon the foregoing first heating source 41 to provide a direct heating for the supporting ring 12 of the preform 10, so that the curve position 13 of the periphery underneath the supporting ring 12 can be crystallized. In addition to the bottle mouth 11, the invention also crystallizes the curve position 13 underneath the supporting ring 12, of which the prior art does not do. Thereafter, a polyester container is produced from the preform 10 at the following process, and the situation of non-crystallized curve position 13 or being broken easily can be improved.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bottle mouth crystallization heating method, using an external energy source to directly heat the external side of said bottle mouth by a first heating source to crystallize said bottle mouth when a preform being mounted onto a plug finger of a base by said bottle mouth, comprising:
a second heating source, for heating a heat absorber of said preform being exposed at the bottom of said plug finger, thereby said heat absorber absorbing heat and then conducting heat from said heat absorber to said plug finger; and
said plug finger with heat energy heating the internal side of said bottle mouth at the same time to disperse heat energy rapidly and evenly at said bottle mouth and improve the degree of crystallization at the internal and external sides of said bottle mouth.

2. The bottle mouth crystallization heating method of claim 1, wherein said first heating source and said second heating source adopt a heat source selected from the collection of a near infrared light source, a far infrared light source and an electric-heated hot wind.

3. The bottle mouth crystallization heating method of claim 1, wherein said heat absorber and said plug finger are made of an excellent heat conductive material having a high coefficient of expansion.

4. The bottle mouth crystallization heating method of claim 1, wherein said heat absorber comprises a concave surface disposed on a lateral side for increasing the absorbability of said heat absorber.

5. The bottle mouth crystallization heating method of claim 1, wherein said first heating source further comprises a third heating source thereon for directly heating a supporting ring of said preform as to crystallize a curve position at the periphery of said supporting ring.

6. The bottle mouth crystallization heating method of claim 5, wherein said third heating source is a heating source selected from the collection of a near infrared light source, a far infrared light source and an electric-heated hot wind.
